(19) United States
(12) Patent Application Publication
(10) Pub. No.: US 2025/0186300 A1
(43) Pub. Date: Jun. 12, 2025

(54) Tuning Fork Handle and Boot For Therapeutic Vibrational Device

(71) Applicant: Todd L. Gardner, Batavia (IL)

(72) Inventor: Todd L. Gardner, Batavia (IL)

(21) Appl. No.: 18/926,011

(22) Filed: Oct. 24, 2024

Related U.S. Application Data
(60) Provisional application No. 63/592,829, filed on Oct. 24, 2023.

(51) Int. Cl. A61H 23/00; A61H 23/06

(52) U.S. Cl. CPC A61H 23/004; A61H 23/06; A61H 2201/0153; A61H 2201/0157; A61H 2201/1253; A61H 2201/169

(57) ABSTRACT

An improved handle for a tuning fork having tines connected to a shaft. The handle can have a longitudinal length sufficient to accommodate a user's hand. The handle can have a longitudinal bore for receiving the shaft. The shaft can be positioned into the bore and connected to the handle at a longitudinal position farthest from the tines. The bore can be sized to provide an annular gap between the handle and the shaft along most of the length of the handle. The handle can be formed with or attached to a head or “boot” having a bumpy surface. The bumpy surface is sized and shaped to contact a patient to transmit vibrations to the patient for therapeutic benefits during treatment.

This application claims the benefit of U.S. Provisional Application Ser. No. 63/592,829, filed Oct. 24, 2023.

### BACKGROUND

A recent study has shown that mechanical stimulation can repair muscle. McAlpine, Kat J. “Wyss and SEAS teams find new strength in regenerative medicine,” Harvard Gazette, Jan. 26, 2016, reporting on a study by Wyss Institute for Biologically Inspired Engineering at Harvard University, and Harvard John A. Paulson School of Engineering and Applied Silences (SEAS).

Tuning forks for applying vibration to a patient for therapeutic treatment and massage are known. U.S. Pat. No. 7,381,193 discloses smooth crowned heads for patient contact. U.S. Pat. No. 8,282,586 and US Patent Application 2017/0348185 disclose tuning fork therapeutic devices having heads of various shapes.

The present inventors have recognized that heretofore known vibrational therapy devices could be improved, particularly the portion of the device that contacts the patient's skin.

### SUMMARY

The exemplary embodiment of the present invention provides an improved tuning fork handle and an improved boot for a therapeutic vibration device such as a tuning fork. These two improvements are inventive together or separately.

One aspect of the invention provides an improved handle for a tuning fork, including, but not limited to, a tuning fork useful in a therapeutic vibrational device. The tuning fork has tines connected to a shaft. The handle can have a longitudinal length sufficient to accommodate a user's hand. The handle can have a longitudinal bore for receiving the shaft. The shaft can be positioned into the bore and connected to the handle at a longitudinal position farthest from the tines. The bore can be sized to provide an annular gap between the handle and the shaft along most of the length of the handle. This reduces the effect of gripping of the handle on the vibration of the tines. The use of such a handle can reduce damping of the tuning fork, caused by gripping of the shaft, and allows for a 200% increase in ring time of the tuning fork. This improvement is useful for therapeutic devices and for tuning forks in general.

According to another aspect of the invention, a therapeutic vibration device applies vibration to a patient, and includes a vibration generator having an end, and a head or “boot” attached to, or formed with, the end of the generator and having a bumpy surface. The bumpy surface is sized and shaped to contact a patient to transmit vibrations to the patient for therapeutic benefits during treatment. The bumpy surface can be substantially spherically contoured. The bumpy surface can have a dome or other convex shape.

For a therapeutic tuning fork, the boot can be attached to the end of the tuning fork and has an irregular surface sized and shaped to contact a patient to transmit vibrations to the patient for therapeutic benefits. The irregular surface can be a bumpy surface. The bumpy surface can be a substantially smooth surface having bumps. The bumpy surface can be substantially spherically contoured. The bumpy surface can have a dome or other convex shape. The boot can be part of a handle that is attached to a shaft of the tuning fork.

The exemplary embodiment of the present invention provides an improved boot that can be used with a tuning fork or other vibrating therapeutic device. The boot can have an irregular surface sized and shaped to contact a patient to transmit vibrations to the patient for therapeutic benefits. The irregular surface can be a bumpy surface. The bumpy surface can be a substantially smooth surface having bumps. The bumpy surface can be substantially spherically contoured. The bumpy surface can have a dome or other convex shape. The boot can be part of, or connected to, a handle that is attached to a shaft of the tuning fork.

In comparison, a smooth surface applied over the surface of tissue may not achieve the same kind of identification and focused resonance that the bumpy surface provides.

When the boot is combined with a tuning fork, this simple apparatus can deliver relief to sore muscles and may speed healing. Muscle tone may be improved through regular application of vibration through this technique. Muscle tension may be reduced and muscle strength may be increased. The apparatus provides benefits to the patient's muscles and provides benefits on a cellular level. Alternately, instead of a boot, a small treating end can be used against the patient's skin or only near to the patient to treat the patient's energy field.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is an elevational view of an exemplary embodiment tuning fork treatment apparatus of the invention;

FIG. 2 is a left end view of the apparatus of FIG. 1;

FIG. 3 is an elevation view of a portion of the apparatus of FIG. 1;

FIG. 4 is an elevational view of an alternate exemplary embodiment handle for a tuning fork of the invention; and

FIG. 5 is a left end view of the apparatus of FIG. 4.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

This application incorporates by reference U.S. Provisional Application Ser. No. 63/592,829, filed Oct. 24, 2023, in its entirety.

U.S. Pat. Nos. 7,381,193; 8,282,586 and US Patent Application 2017/0348185 are all herein incorporated by reference to the extent that they are not contrary to the present disclosure.

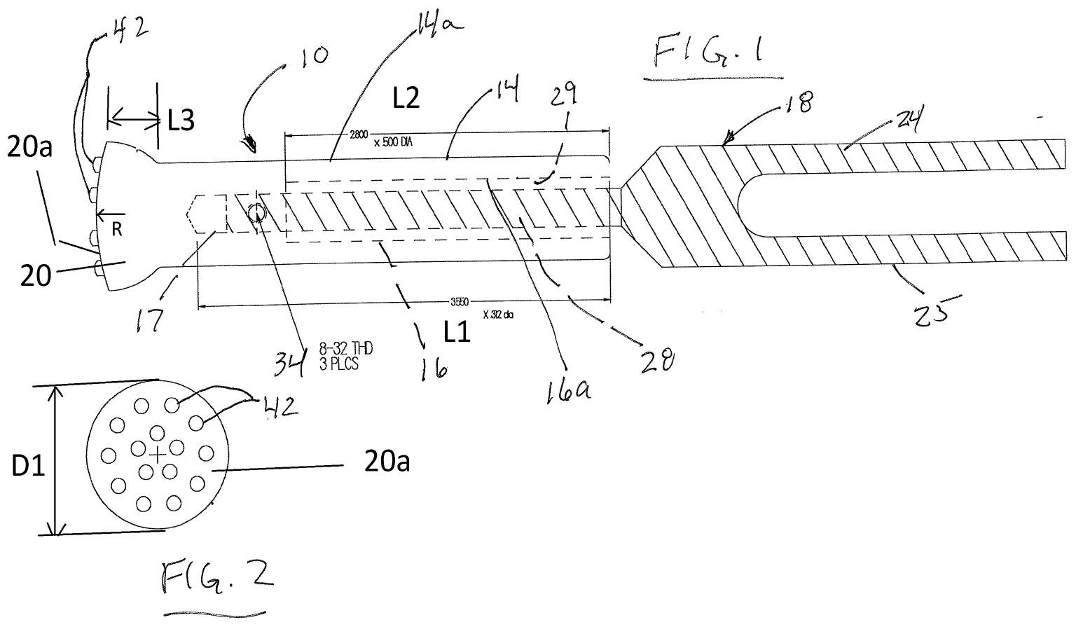

FIGS. 1-3 illustrate a vibrational therapeutic device 10. The device includes a handle 14 connected to a tuning fork 18. One end of the handle 14 includes a boot or treating surface 20. The handle 14 includes a central bore including a narrow bore end 17 open to a longitudinal bore 16. The tuning fork 18 includes tines 24, 25 and a shaft 28.

According to this embodiment, the shaft 28 is connected to the handle 14 within the narrow bore end 17 by one or more set screws 34 threaded into one or more threaded bores (see 34a in FIG. 5) in the handle 14, adhesive, press fitting or other connection means. One exemplary embodiment includes three set screws 34 arranged around the handle 14 and spaced at 120 degrees. There is an annular space 29 between the shaft 28 and an inside surface 16a of the longitudinal bore 16. The handle 14 includes a gripping surface 14a. The annular space 29 causes a reduced influence of the handle on the tuning fork particularly on higher frequencies.

FIGS. 1-3 illustrate bumps 42 on a treatment surface 20a of the boot 20. These bumps can be randomly spaced on the surface or regularly spaced. The bumps enhance the vibrational treatment interaction between the boot 20 and the patient's skin.

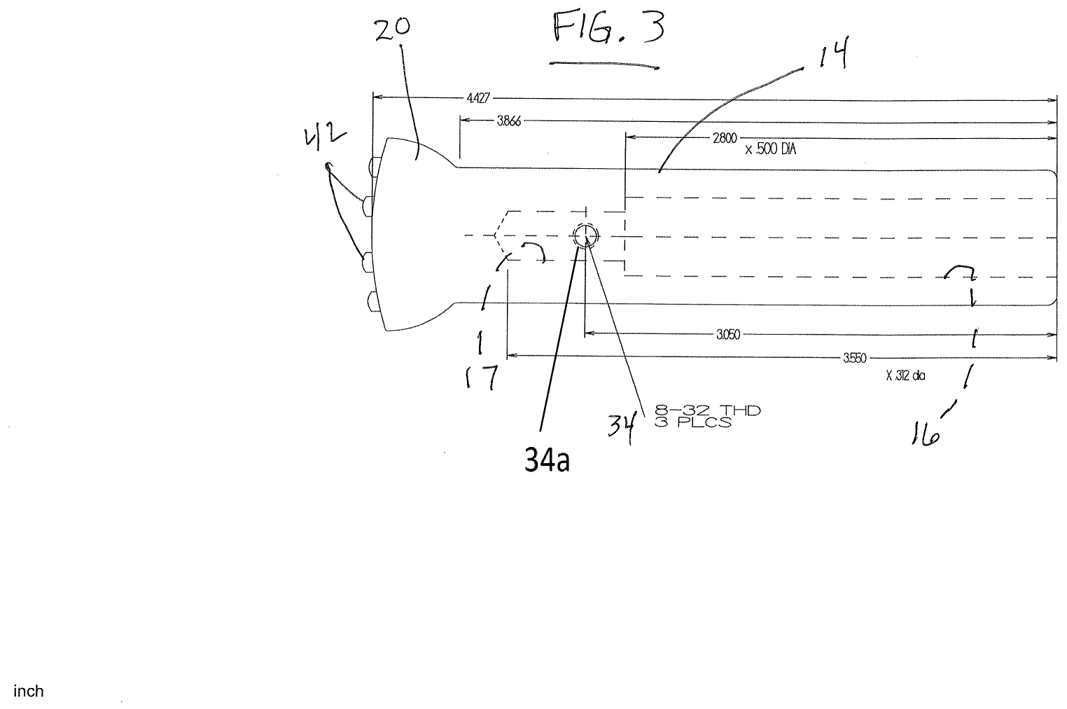

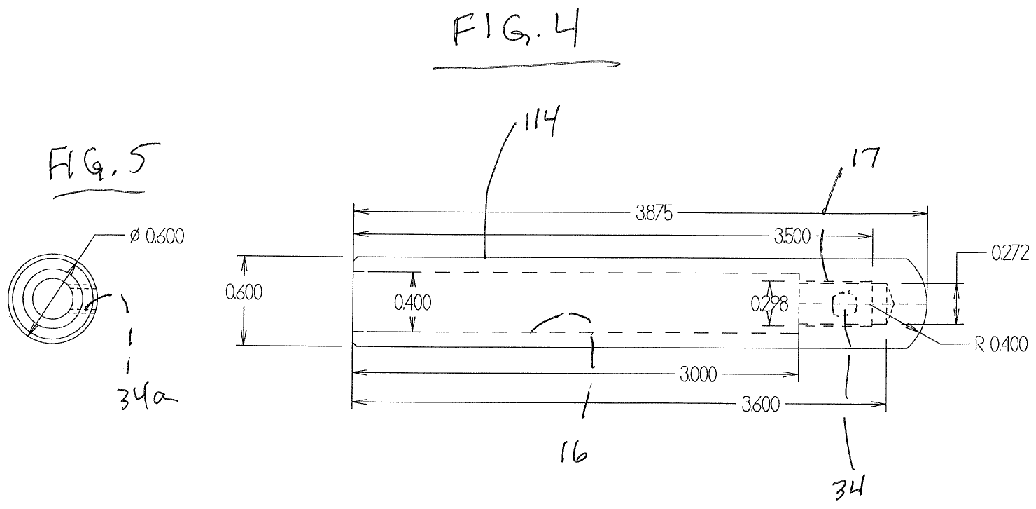

FIG. 4 shows a handle 114 similar to the handle 14 of FIG. 3 but without a treatment surface or boot 20. FIG. 4 shows a threaded bore 34a for a set screw to hold a tuning fork (not shown). The handle 114 may be useful for multiple tuning fork applications, including treatment applications; the handle not being limited to treatment applications. The handle 114 for holding a tuning fork would benefit non-therapeutic tuning forks.

The boot 20 and handle 14 or handle 114 can have the following exemplary dimensions, although other dimensions are encompassed by the invention: The diameter of the boot D1 can be within a range of between 1.5 and 0.5 inches. The length L1 of the handle can be 3.6 inches. The length L2 of the longitudinal bore 16 in the handle 14 to the end of the handle 14 can be about 3.0 inches. The length L3 of the boot 20 can be about 0.5 inches. The radius R of the spherically contoured end surface of the boot can be within a range of about 2.0 to 0.4 inches. The longitudinal bore 16 can have a diameter of about 0.4 inches.

The bumps 42 can have a diameter withing a range between 0.05 and 0.4 inches, and advantageously about 0.08 inches, inches and can have a height withing a range between 0.03 to 0.4 inches, and advantageously about 0.05 inches. Although 15 bumps shown in FIG. 2 is advantageous, other numbers of bumps could also be used. An exemplary number of bumps 42 can be within a range of 3-60 dimples, and more advantageously between 4-36 dimples.

Exemplary composition of the components are:
Boot: stainless steel, aluminum, quartz, glass, stone, plastic or other suitable material.
Tuning fork: aluminum or steel or other suitable material.
Handle: aluminum or steel or other suitable material.

From the foregoing, it will be observed that numerous variations and modifications may be incorporated without departing from the spirit and scope of the invention. It is to be understood that no limitation with respect to the specific apparatus illustrated herein is intended or should be inferred.

The invention claimed is:

1. A therapeutic vibration device for applying vibration to a patient, comprising:
a vibration generator having an end; and
a handle attached to the end of the vibration generator and having a bumpy treatment surface sized and shaped to contact a patient to transmit vibrations to the patient for therapeutic benefits, the handle connected to the vibration generator at a position close to the treatment surface allowing an annular space between the handle and the vibration generator throughout most of the length of the handle.

2. The device of claim 1, wherein the vibration generator comprises a tuning fork having tines connected to an elongated shaft, the handle surrounding the shaft with an annular space therebetween, the handle sized for a user to grasp the handle, the shaft connected to the handle at a forward position furthest from the tines.

3. The device of claim 1, wherein the treatment surface has a convex surface with individual spaced-apart bumps.

4. A tuning fork having tines connected to an elongated shaft, a handle surrounding the shaft with an annular space therebetween, the handle sized for a user to grasp the handle, the shaft connected to the handle at a forward position furthest from the tines.
